(19) United States
(12) Patent Application Publication
(10) Pub. No.: US 2026/0241351 A1
(43) Pub. Date: Aug. 20, 2026

(54) STIR-FRY DEVICE FOR AUTOMATIC COOKING MACHINE

(71) Applicant: Hestia Technology Limited, Hong Kong (CN)

(72) Inventors: Chim Lee CHEUNG, Hong Kong (CN); Ka Tak LEE, Hong Kong (CN); Hing Choi FU, Hong Kong (CN); Ka Yan WONG, Hong Kong (CN); Man Nga YIU, Hong Kong (CN); Kathy CHAN, Hong Kong (CN); Ka Chi YIP, Hong Kong (CN); Zhi Xing YAO, Hong Kong (CN); Kwok Yin WU, Hong Kong (CN); Kwong Leung Eckert SUM, Hong Kong (CN); Ka Lok YIU, Hong Kong (CN)

(21) Appl. No.: 19/539,626

(22) Filed: Feb. 13, 2026

Related U.S. Application Data
(60) Provisional application No. 63/758,534, filed on Feb. 14, 2025.

(51) Int. Cl. B01F 27/1125; A47J 36/00; A47J 37/12; A47J 43/046

(52) U.S. Cl. CPC B01F 27/11251; A47J 36/00; A47J 37/1228; A47J 43/046

(57) ABSTRACT

A stir-fry device for an automatic cooking machine includes a stirring paddle, a connection part, and a driving part. The stirring paddle has a rotating shaft arranged along a central axis of a cooking pot, a vertical plate-like stirring blade extending from the rotating shaft toward an inner wall of the cooking pot, and a stirring head disposed adjacent the inner wall. The stirring blade has a width in a range from about 5 mm to about 12 mm and a thickness in a range from about 1.6 mm to about 3 mm, with a stirring blade gap of about 2 mm to about 11 mm defined between a lower edge of the stirring blade and at least one of a connection-part surface and the inner wall, and a stirring head gap of about 2 mm defined between a rear surface of the stirring head and the inner wall. The connection part includes a blade seat receiving the rotating shaft, magnet fixed to the blade seat, and a magnetic base connector fixed to the cooking pot, providing a detachable magnetic coupling that facilitates exchanging different stirring paddles.

### CROSS-REFERENCE TO RELATED APPLICATION

This application is based on and claims the benefit of priority from the U.S. Provisional Patent Application No. 63/758,534, filed on 14 Feb. 2025, the entirety of which is incorporated by reference herein.

### TECHNICAL FIELD

The present disclosure relates to automatic cooking machines, and more particularly to a stir-fry device containing a stirring paddle configured for use in commercial or domestic automatic cooking machines.

### BACKGROUND

Automatic cooking machines have been developed for commercial and domestic use to automate various cooking processes and reduce reliance on manual operation. Stir-frying is a commonly used cooking technique that can significantly affect the quality of a dish, for example by helping to distribute ingredients, promote even heating, and mechanically break ingredients into smaller pieces. Existing automatic cooking machines may include stirring paddles or similar mechanisms to implement a stir-fry function, but such devices can exhibit limitations in actual use.

In some implementations, food ingredients may adhere to the stirring paddle or to an inner wall of a cooking pot during operation, which can adversely affect heating uniformity and cleaning convenience. In other cases, ingredients may become trapped between the stirring paddle and the pot wall, potentially leading to incomplete stirring or damage to the ingredients. Certain paddle geometries may also struggle to effectively handle long or skinny food items, pastes, rice, or minced meat, which can result in clumping and non-uniform texture. Furthermore, some stir-fry devices are not designed to be detachably mounted or replaced with different paddles, which may limit flexibility in addressing different ingredients or cooking modes.

### SUMMARY

The present disclosure provides a stir-fry device for an automatic cooking machine, the stir-fry device comprising a stirring paddle, a connection part, and a driving part. The stirring paddle includes a rotating shaft arranged substantially at a center of a cooking pot, a stirring blade connected to the rotating shaft, and a stirring head connected to the stirring blade. The stirring blade is formed as a substantially vertical plate extending adjacent an inner wall of the cooking pot, with a width in a range from about 5 mm to about 12 mm to provide an effective collision area for contacting ingredients, and with a thickness in a range from about 1.6 mm to about 3 mm to reduce adhesion of ingredients to upper and lower edges of the stirring blade. A stirring blade gap is defined between a lower edge of the stirring blade and the inner wall of the cooking pot at the bottom, the stirring blade gap having a width in a range from about 2 mm to about 11 mm to reduce trapping of ingredients between the stirring blade and the inner wall.

The stirring head is disposed at an end of the stirring blade opposite the rotating shaft, and a stirring head gap is defined between a rear surface of the stirring head and the inner wall of the cooking pot, the stirring head gap having a width of about 2 mm so as to inhibit collision between the stirring head and the inner wall while reducing trapping of ingredients in the gap. In some embodiments, the stirring head is formed as a vertical plate to provide an additional lateral surface area that promotes stir-fry movement and mixing of ingredients. In other embodiments, the stirring head has a rake-like structure including a ridge and at least four arms, with at least two arms extending from a first side of the ridge and at least two arms extending from a second, opposite side of the ridge, inner arcs being formed between adjacent arms on a same side of the ridge to enhance cutting performance. Preferably, rear surfaces of the arms are arranged substantially adjacent to the inner wall of the cooking pot, and distal ends of the arms are formed as pointed tips to improve splitting or tearing of ingredients such as long strips, paste, rice, or minced meat.

The connection part connects the stirring paddle to the cooking pot and facilitates exchanging different stirring paddles suited for different dishes, and includes a blade seat, one or more magnets, and a base connector. The rotating shaft is received in the blade seat, and a bottom of the blade seat is fixed to the magnets. The base connector, which is formed of a magnetic material, is fixed to the cooking pot such that magnetic attraction is established between the blade seat and the base connector to removably couple the stirring paddle to the cooking pot. The driving part drives the rotating shaft to rotate relative to the inner wall of the cooking pot and includes a motor configured to transmit a driving force to the rotating shaft. The driving part further includes a stirring paddle home position, a home sensor, and a home magnet, the home magnet rotating together with the rotating shaft, and the home sensor being disposed at a fixed position to detect the home magnet and thereby identify the stirring paddle home position to facilitate pouring cooked dishes toward a central region of a serving dish. In some implementations, the motor drives the rotating shaft to rotate in a direction opposite to a rotational direction of the cooking pot, such that when the cooking pot rotates in a clockwise direction the rotating shaft rotates in a counterclockwise direction, and when the cooking pot rotates in a counterclockwise direction the rotating shaft rotates in a clockwise direction, thereby enhancing stirring and mixing performance.

### BRIEF DESCRIPTION OF DRAWINGS

The present disclosure will be further described below with reference to the accompanying drawings and embodiments, in which:

FIG. 1 is structural schematic view of the present invention installed in a cooking machine;

FIG. 2 is structural schematic view of the present invention installed in a cooking machine in another angle;

FIG. 3 is a structural schematic view of a stirring paddle (embodiment A) of the present invention;

FIG. 4 is a cross sectional view along x-axis of the present invention (embodiment A) installed in a cooking machine;

FIG. 5 is a top view of the present invention (embodiment A) installed in a cooking machine;

FIG. 6 is a cross sectional view along y-axis of the present invention (embodiment A) installed in a cooking machine;

FIG. 7 is a cross sectional view along x-axis of the present invention (embodiment A) installed in a cooking machine, with parameters included;

FIG. 8 is a top view of the present invention (embodiment A) installed in a cooking machine, with parameters included;

FIG. 9 is a structural schematic view of a stirring paddle (embodiment B) of the present invention;

FIG. 10 is a front view of a stirring paddle (embodiment B) of the present invention;

FIG. 11 is side view of a stirring paddle (embodiment B) of the present invention;

FIG. 12 is a cross sectional view along x-axis of the present invention (embodiment B) installed in a cooking machine;

FIG. 13 is a top view of the present invention installed in a cooking machine (stirring paddle-embodiment B);

FIG. 14 is a cross sectional view along y-axis of the present invention (embodiment B) installed in a cooking machine;

FIG. 15 is a cross sectional view along x-axis of the present invention (embodiment B) installed in a cooking machine, with parameters included;

FIG. 16 is a top view of the present invention (embodiment B) installed in a cooking machine, with parameters included;

FIG. 17 is a cross-sectional view of connection part of the present invention;

FIG. 18a is a bottom view of the blade seat of the connection part of the present invention;

FIG. 18b is a structural schematic view of the blade seat of the connection part of the present invention;

FIG. 19a is structural schematic view of the plugged base connector with the cooking pot of the present invention;

FIG. 19b are structural schematic view of the unplugged base connector with the cooking pot of the present invention;

FIG. 20 is structural schematic view of the motor's end effector (flat-blade pattern) of the driving part of the present invention

FIGS. 21a & 21b are structural schematic view of the stirring paddle home position of the present invention

FIG. 22 is a structural schematic view of the motor's end effector of the of the present invention

FIG. 23 is a structural schematic view of the active blade shaft and blade shaft flag of the present invention

FIG. 24 is a structural schematic view of a chain of gear connection of the driving part of the present invention

FIG. 25 is a structural schematic view of motor of the driving part of the present invention

FIGS. 26a, 26b, 26c and 26d are structural schematic view of home sensor and home magnet of the driving part of the present invention;

FIG. 27 is a cross-sectional view of connection part of the present invention.

FIG. 28 is an exploded structural view of connection part of the present invention.

### DETAILED DESCRIPTION

Embodiments of the present disclosure will be described in detail below. Examples of the embodiments are illustrated in the accompanying drawings, where the same or like reference numerals throughout the figures indicate the same or like elements having the same or like functions. The embodiments described below with reference to the accompanying drawings are exemplary and are intended only to explain the present disclosure instead of being construed as limiting the present disclosure.

In the description of the disclosure, reference to the terms such as “an embodiment”, “some embodiments”, “exemplary embodiment”, “example”, “specific example” and “some examples” means that a particular feature, structure, material, or characteristic described in connection with the embodiment or example is included in at least one embodiment or example of the present invention. In this specification, the schematic representations of the terms above do not necessarily refer to the same embodiment or example. Furthermore, the particular feature, structure, material, or characteristic described may be combined in any suitable manner in any one or more embodiments or examples.

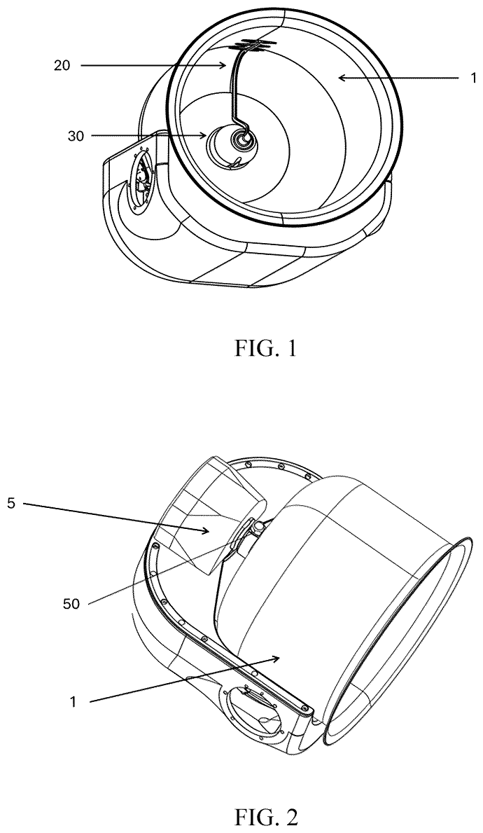

Referring to FIGS. 1 to 2, embodiments of the present disclosure provides a stir-fry device for automatic cooking machine, comprising: a cooking pot 1, a stirring paddle 20, a connection part 30 and a driving part 5. The cooking pot 1 is connected to the driving part 5 by screw 50. The connection part 30 secures the cooking pot 1 to the driving part 5 while allowing power to be transmitted through connection part 30 to the stirring paddle 20.

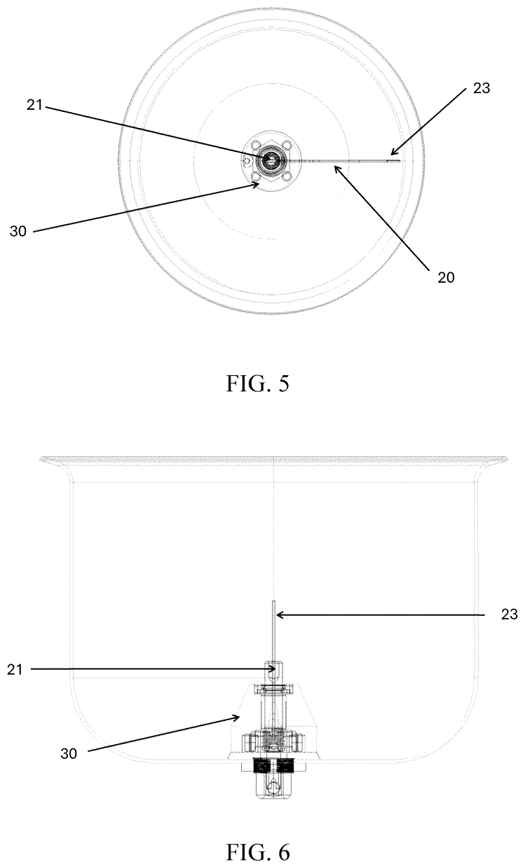

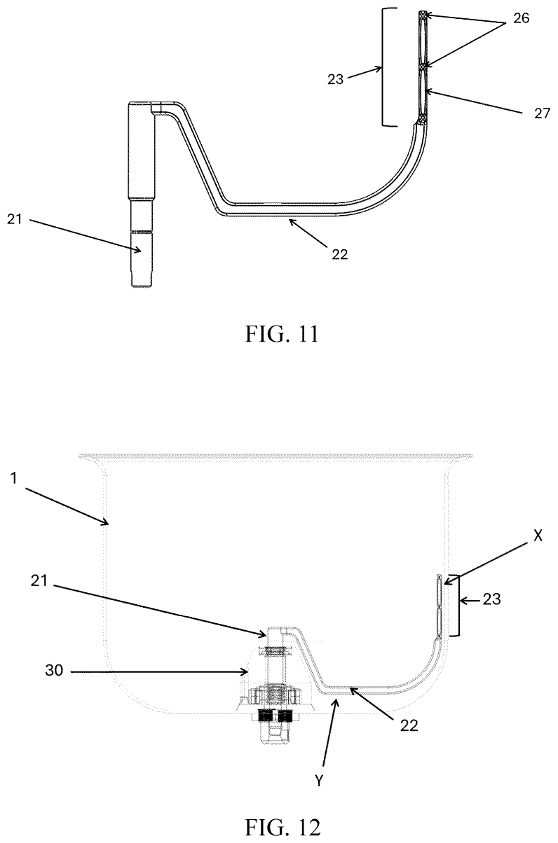

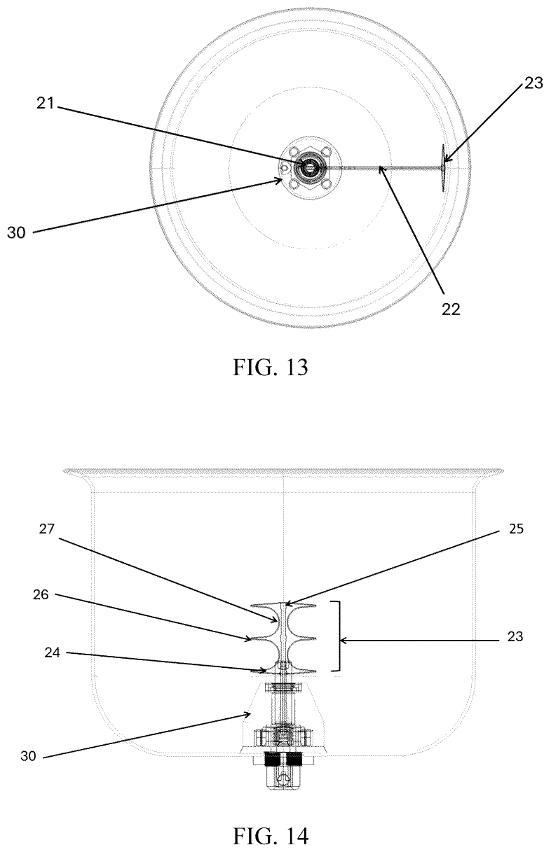

As shown in FIGS. 1 to 17, the stirring paddle 20 of the stir-fry device includes a rotating shaft 21, a stirring blade 22 and a stirring head 23. The rotating shaft 21 is arranged at the center of the cooking pot 1 and penetrates vertically through the bottom wall of the cooking pot 1. The middle and lower portion of the rotating shaft 21 is surrounded by the connection part 30. The upper portion of the rotating shaft 21 is protruded up from the connection part 30 with its upper end connected to one end of the stirring blade 22. The upper and middle portions of the rotating shaft 21 are located at the inner side of the cooking pot 1. The lower end of the rotating shaft 21 is located outside the cooking pot 1 and is connected to the driving part 5. The driving part 5 is configured to drive the rotating shaft 21 to rotate relative to the inner wall of the cooking pot 1. The stirring blade 22 is a vertical plate arranged perpendicularly with respect to the inner wall of the cooking pot 1. The stirring blade extends along the surface of the connection part 30 and the inner wall of the cooking pot 1 from the center of the cooking pot 1 to the side wall of the cooking pot 1.

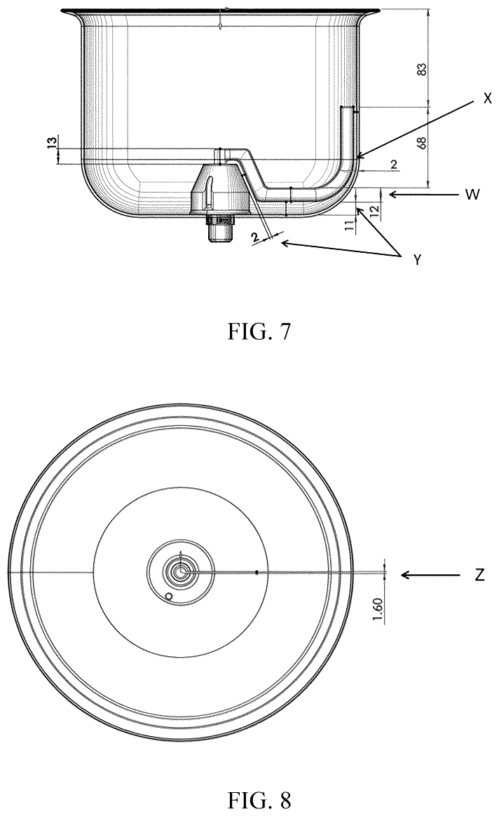

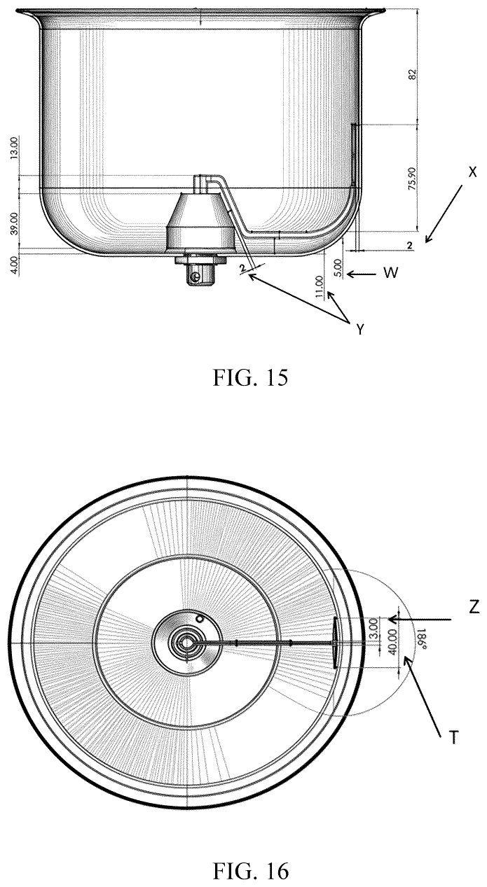

As shown in FIG. 7, the width of the stirring blade (W) of embodiment A is 12 mm. As shown in FIG. 15, the width of the stirring blade (W) of embodiment B is 5 mm. The lateral surface area of the stirring blade in this range of width provides a suitable collision area against the ingredients when the stirring blade is forced to rotate along the inner wall of the cooking pot 1. Therefore, it provides an efficient stir-fry movement.

As shown in FIGS. 4, 7, 12 and 15, a stirring blade gap (Y) is provided between the lower edge of the stirring blade and the surface of the connection part 30, and between the lower edge of the stirring blade and the inner wall of the cooking pot 1. The width of the stirring blade gap (Y) is between 2 mm to 11 mm. This width range can prevent the ingredients from trapping between the stirring blade and the inner wall of the cooking pot 1 and between the lower edge of the stirring blade and the surface of the connection part 30. Therefore, it reduces the difficulty of cleaning and increasing the efficiency of auto-cleaning. It also prevents the stirring blade from crushing against the inner wall of the cooking pot 1.

As shown in FIG. 8, the thickness of the stirring blade of embodiment A is 1.6 mm. As shown in FIG. 16, the thickness of the stirring blade of embodiment B is 3 mm. This distance prevents ingredients from sticking on the upper and lower edges of the stirring blade.

As shown in FIGS. 1 to 17, the other end of the stirring blade which is extended away from the rotating shaft 21 is connected to the stirring head 23. The stirring head 23 is arranged along the inner side wall of the cooking pot 1. Preferably, the upper end of the stirring head 23 is arranged at a height close to the mid-height level of the cooking pot 1. Preferably, the stirring head 23 is arranged along the vertical side wall.

As shown in FIGS. 1 to 17, a stirring head gap (X) is provided between the rear surface of the stirring head 23 and the inner wall of the cooking pot 1. The width of the stirring head gap (X) is 2 mm. The stirring head gap (X) is configured to prevent the stirring head 23 from crushing against the inner wall of the cooking pot 1. It also prevents the ingredient from trapping between the stirring head 23 and the inner wall of the cooking pot 1, therefore facilitating the cleaning process of the stirring paddle 20 and the cooking pot 1 when used.

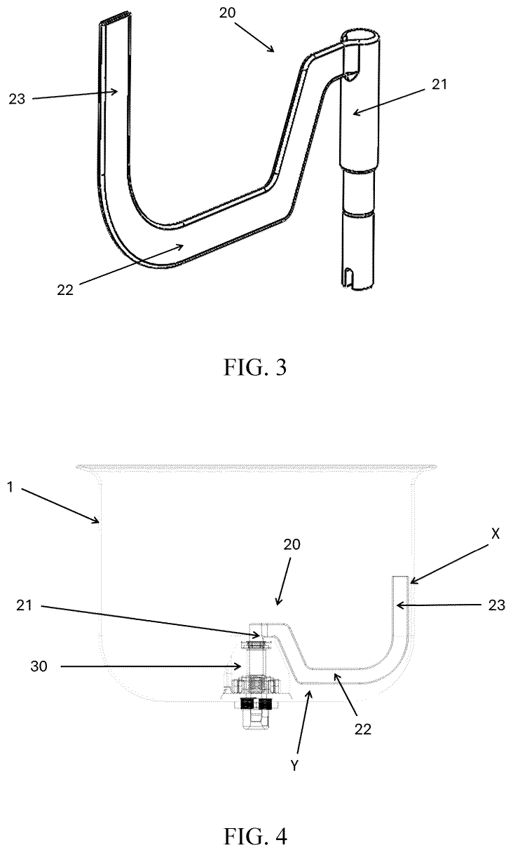

Optionally, as shown in FIGS. 3 to 8, the stirring head 23 of embodiment A is a vertical plate that is extended from the end of the stirring blade 22. It has the same width and thickness as the stirring blade 22 and is arranged perpendicularly with respect to the wall of the cooking pot 1. This type of stirring head 23 provides additional lateral surface area which favors the stir-fry movement of the ingredients to mix them evenly.

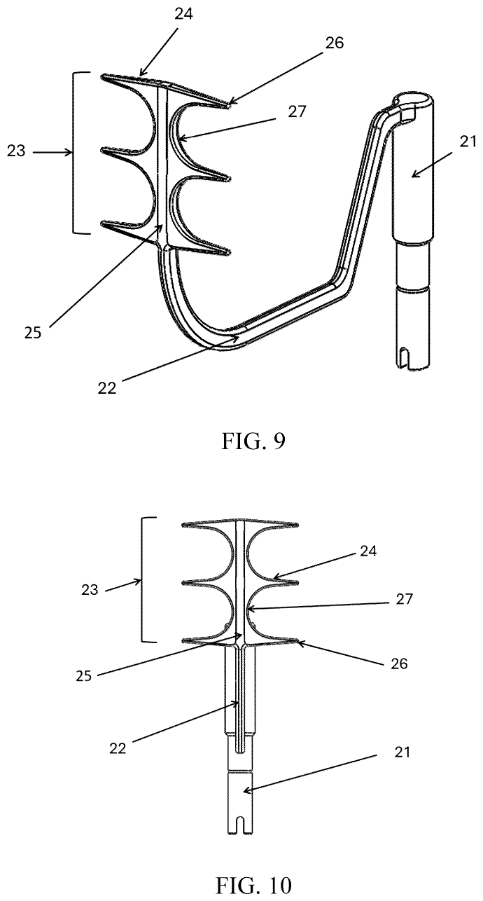

Optionally, as shown in FIGS. 9 to 16, the stirring head 23 of embodiment B is a rake-like structure, comprising: a ridge 25 and six arms. One end of the arms is connected to the ridge 25, another end of the arms has a pointed tip 26. Three arms are connected to the right-hand side of the ridge 25 and three arms are connected to the left-hand side of the ridge 25. In between each of the two arms on the same side of the ridge 25 is an inner arc 27. Each arm 24 on each side of the ridge 25 is arranged horizontally and is aligned at the same height with respect to the other arm on the other side of the ridge 25.

As shown in FIGS. 9 to 16, the ridge 25 of the stirring head 23 is arranged in an upright position, and the rear surface of all arms on the same side is arranged superficially adjacent to the inner wall of the cooking pot 1. The end of the stirring blade 22 which is extended away from the rotating shaft 21 is connected to the lower end of the ridge 25. The pointed end of the stirring head 23 favors the separation of the clumps or paste ingredients, it possesses a strong cutting ability to split or tear the ingredient apart into smaller pieces. The inner arc 27 between the arms allows the ingredient to pass without breaking it, thus it favors the food form into strips. As shown in FIG. 16, the width of stirring head (T) of embodiment B is 40 mm.

The width of the stirring blade (W) can vary depending on the size of the ingredient. A suitable width provides a suitable lateral area for the stir-fry movement which highly impact the efficiency of cooking and the quality of the dishes.

Preferably, for cooking dishes including cooked rice, the width of the stirring blade (W) is 5 mm.

Preferably, for cooking dishes including noodles or vegetables, the width of the stirring blade (W) is 12 mm.

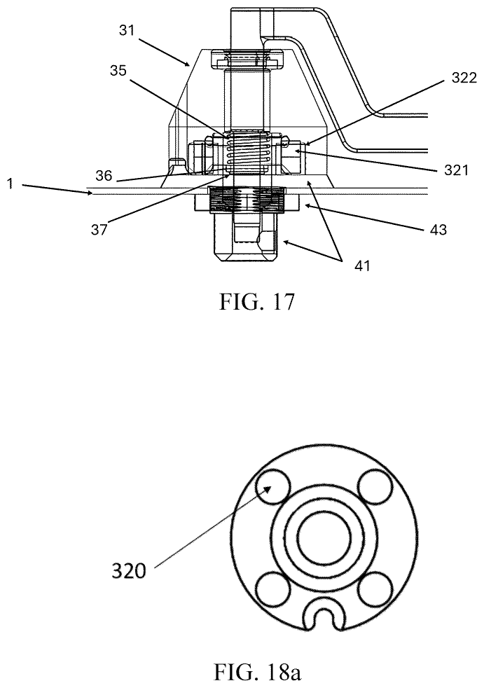

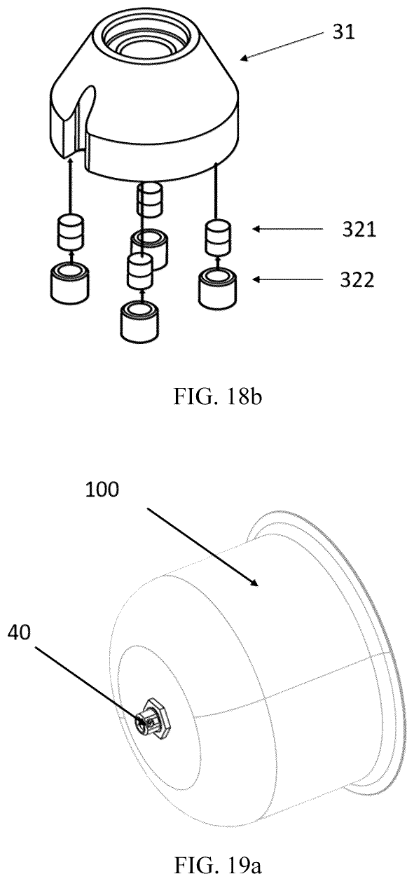

As shown in FIGS. 17 to 18, the connection part 30 of the stir-fry device comprising: a blade seat 31, a spring 35, a spacer 36, a retaining ring 37, magnet caps 322, magnets 321, a pot connector 41 and a connector ring 43. The connection part 30 serves to connect the stirring paddle 20 to the cooking pot 1, it also facilitates the ease of exchange for the suitable stirring paddle 20 for different dishes.

As shown in FIG. 17, the rotating shaft 21 is inserted into the blade seat 31 from the top of the blade seat 31 and passes through it. The spring, the washer, and the retaining ring are installed from the bottom to the rotating shaft 21 in order. A slit on the rotating shaft 21 secures and fixes the retaining ring's position and compresses the spring so that the rotating shaft 21 remains in the blade seat 31. The spring is used to secure the rotating shaft 21 inside the blade seat 31 and to limit the distance between the rotating shaft 21 and the central axis of the cooking pot 1, to ensure the rotating shaft 21 connects tightly to the central axis of the cooking pot 1.

As shown in FIG. 18, the blade seat 31 comprised magnet hole 320 for installing the magnet 321. Specifically, the blade seat 31 has four holes with a 10 mm depth on the bottom of it. Two magnets (6 mm in diameter and 5 mm long) with end caps are joined with each hole of the blade seat 31 using a pressing machine and a specific jig. Since the end cap's outer diameter is slightly greater than the holes in the blade seat 31, they permanently join together after force and pressing, allowing them to be treated as one unit.

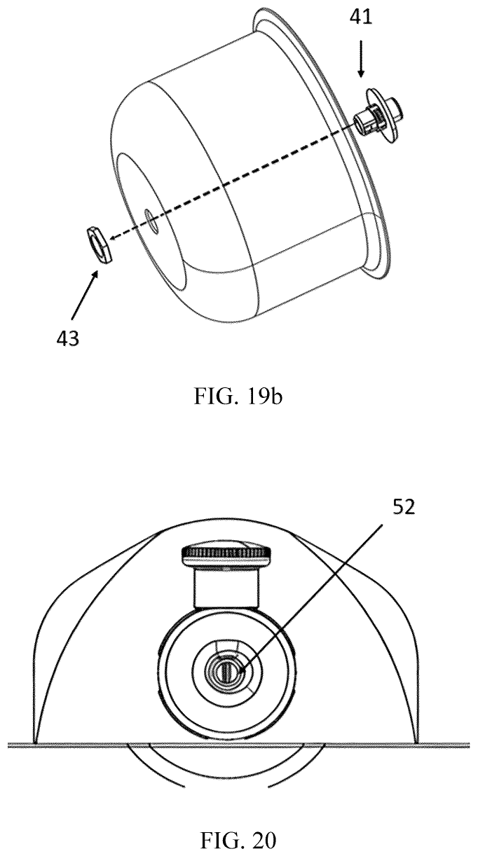

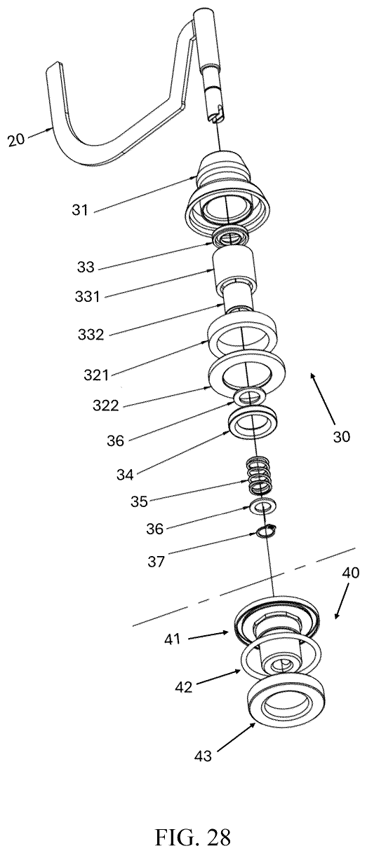

As shown in FIG. 19, the base connector 40 is connected to the bottom of the cooking pot 1. A central opening is located on the base connector 40 allowing the rotating shaft 21 from the blade seat 31 to penetrate through and to connect with the driving part 5. Specifically, refer to FIG. 28 the upper portion of the base connector is a pot connector 41. The lower portion of the base connector is a connector ring 43. An O-ring 42 could be configured in between the pot connector 41 and connector ring 43 to increase water-proofing function. The connector ring 43 could be a standard component like M24 nut. The one end of the pot connector 41 passes through the central opening on the bottom wall of the cooking pot 1. The cooking pot 1 and pot connector 41 could also be mated by and it could be treated as one body.

As shown in FIG. 19, the base connector is made of magnetic material, a material that can attract magnets. Preferably, the magnetic material be AISI430. The blade seat 31 contains magnets, so there will be magnetic attraction between the upper surface of the base connector and the bottom surface of the blade seat 31. Therefore, the blade seat 31 is detachably connected to the base connector allowing the exchange of the blade seat 31 with different stirring paddle 20s easily.

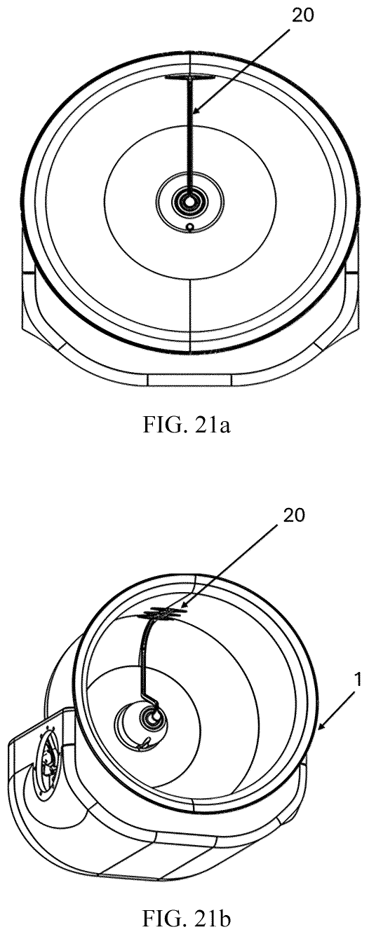

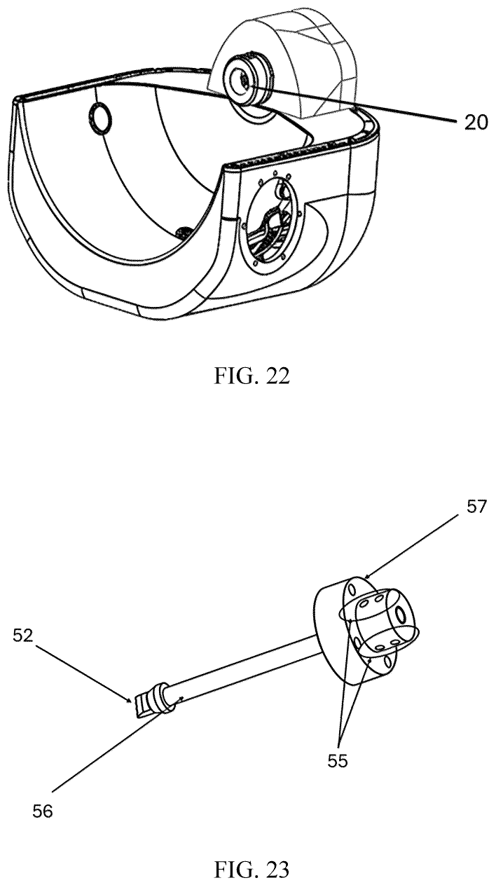

As shown in FIG. 20 to 26, the driving part 5 of the stir-fry device comprising: a motor 51, an active blade shaft 56, a blade shaft flag 57, a stirring paddle 20 at home position, a home sensor 58 and a home magnet 59; wherein, the active blade shaft 56 includes a motor's end effector 52. The driving part 5 serves to provide the moving force for the stirring paddle 20 to rotate along the inner wall of the cooking pot 1.

Specifically, as shown in FIGS. 20, 22 and 23, the motor 51 drives the movement of the rotating shaft 21 by using a flat-blade pattern. The lower end of the rotating shaft 21 has a flat-blade hole pattern that matches the motor's end effector 52. When the rotating shaft 21 is mounted on the cooking pot 1, the lower end of the rotating shaft 21 attaches to the motor's end effector 52. As the motor rotates, it drives the rotating shaft 21, similar to how a flat-blade screwdriver turns a flat-blade screw.

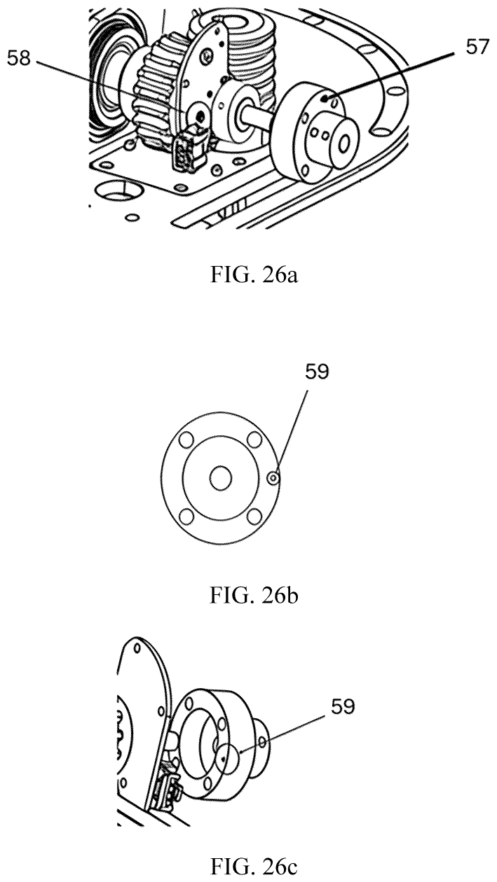

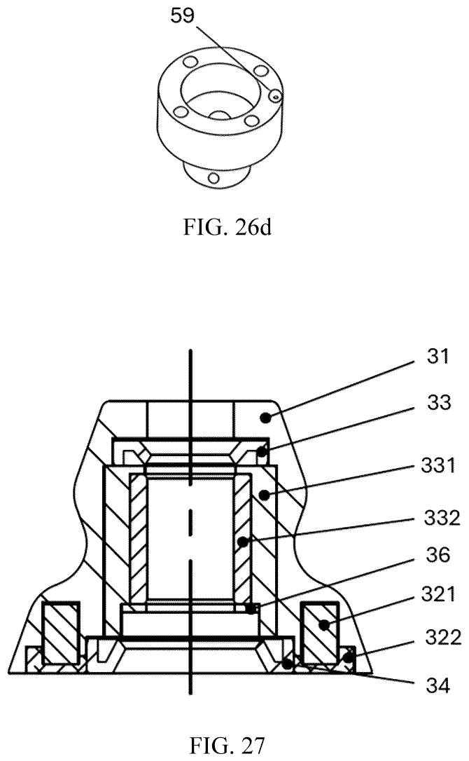

As shown in FIGS. 21 and 26, a stirring paddle 20 home position is provided to coordinate the stirring paddle 20 home position for serving a dish. When at stirring paddle 20 home position arrived, the stirring paddle 20 would point upward. In each process of serving the dish, the stirring paddle 20 would first back to the stirring paddle 20 home position (facing upward). This ensures that during the serving process, the stirring paddle 20 doesn't collide with the food, preventing any disruption to the pouring performance. The driving part 5 serves to rotate and control the rotation of the rotating shaft 21 to the specific position, thus ensuring the dishes are poured onto the centre of the disk.

Specifically, as shown in FIG. 23, the motor's end effector 52 is arranged on the top end of the active blade shaft 56, and the other end of the active blade shaft 56 connects to the blade shaft flag 57 using four set screws on the side. The primary function of the blade shaft flag 57 is to hold a home magnet 59, it allows the home magnet 59 to rotate with the stirring paddle 20 and to be detected by the home sensor 58 when it reaches the stirring paddle 20 home position.

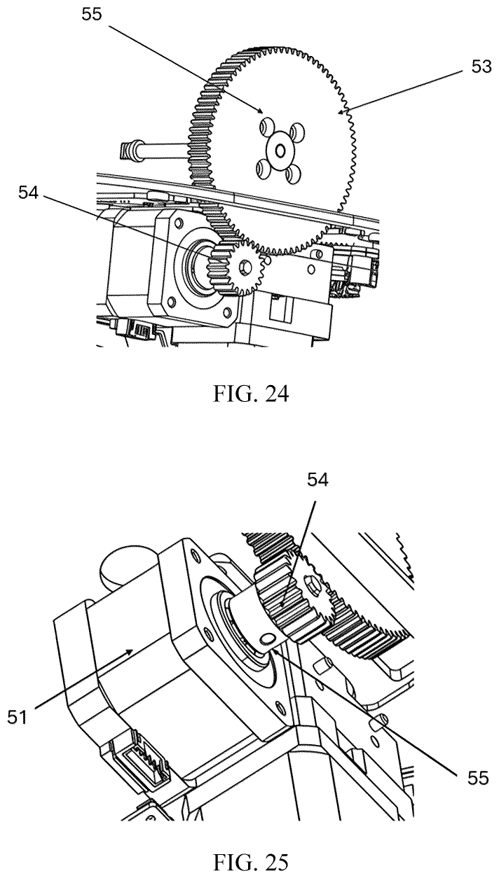

As shown in FIGS. 24-25, the blade shaft flag 57 is connected to the motor 51 through several gears. Specifically, the blade shaft flag 57 is connected to the big spur gear 53 using four C'bore holes on the gear and threaded holes on the blade shaft flag 57. The big spur gear 53 is further connected to the small spur gear 54 through their teeth. This gear connection is primarily used to increase the torque of the blade. The small spur gear 54 is connected to the driving motor shaft using a set screw hole 55 on the gear's cylindrical face.

As shown in FIGS. 27-28, the overall shape of the blade seat 31 is gourd-shaped. with a slight indentation at its center. This design provides a handle position to counteract magnetic force when removing the connection part 30. Regarding the internal structure of connection part 30, various components can be installed in the following sequence: blade seat 31, top seal 33, bushing sleeve 331, bushing 332, spring 35, spacer 36, retaining ring 37 and bottom seal 34,

Preferably, the motor drives the movement of the rotation shaft to rotate in a direction opposite to the rotational direction of the cooking pot 1. When the cooking pot rotate in a clockwise direction, the rotation shaft will be forced to move in counter-clockwise direction. When the cooking pot rotate in a counter-clockwise direction, the rotation shaft will be forced to move in clockwise direction.

The stir-fry device of the present invention may further include an inbuilt hall sensor that allows engineers to control the pot's speed in RPM (Revolutions per minute). Specifically, PID (Proportional-Integral-Derivative) control is used to ensure stable pot rotation during stir-frying, preventing it from rotating too slowly or too quickly.

Preferably, for cooking 30 g of egg, the angle of the central axis of the cooking pot with respect to the horizontal plane is 63°.

Preferably, for cooking 300 g of rice, the angle of the central axis of the cooking pot with respect to the horizontal plane is at the range of 43°-50°.

Additional aspects and advantages of the present disclosure will be set forth in part in the description which follows, and in part will be obvious from the description, or may be learned by practice of the present disclosure.

What is claimed is:

1. A stir-fry device for an automatic cooking machine, comprising:
a cooking pot having an inner wall and a bottom wall;
a stirring paddle including a rotating shaft, a stirring blade, and a stirring head, the rotating shaft extending along a central axis of the cooking pot and penetrating the bottom wall, the stirring blade extending from an upper portion of the rotating shaft toward the inner wall and being arranged substantially perpendicular to the inner wall; and
a connection part configured to connect the rotating shaft to the cooking pot and to permit attachment and removal of the stirring paddle,
wherein the connection part comprises a blade seat receiving a portion of the rotating shaft, at least one magnet fixed to the blade seat, and a base connector fixed to the bottom wall of the cooking pot and formed of a magnetic material attracted by the magnet.

2. The stir-fry device of claim 1, wherein the stirring blade is formed as a substantially vertical plate extending along the inner wall of the cooking pot.

3. The stir-fry device of claim 1, wherein a stirring blade gap is defined between a lower edge of the stirring blade and at least one of a surface of the connection part and the inner wall of the cooking pot, the stirring blade gap having a width selected to reduce trapping of ingredients between the stirring blade and the inner wall.

4. The stir-fry device of claim 1, wherein the stirring blade extends continuously from the rotating shaft to the inner wall of the cooking pot along a surface of the connection part;
the stirring head is connected to an end of the stirring blade opposite the rotating shaft and is arranged adjacent the inner wall of the cooking pot such that an upper end of the stirring head is located proximate a mid-height level of the cooking pot.

5. The stir-fry device of claim 4, wherein the stirring head comprises a vertical plate having substantially the same width and thickness as the stirring blade and arranged substantially perpendicular to the inner wall of the cooking pot.

6. The stir-fry device of claim 4, wherein the stirring head comprises a ridge extending generally vertically; and a plurality of arms extending from the ridge, including at least two arms on a first side of the ridge and at least two arms on a second, opposite side of the ridge, each arm extends horizontally, arms on opposite sides of the ridge are aligned at substantially the same height, and an inner arc is formed between adjacent arms on a same side of the ridge.

7. The device of claim 6, wherein rear surfaces of the arms on each side of the ridge are arranged substantially adjacent to the inner wall of the cooking pot, and distal ends of the arms are formed as pointed tips configured to split or tear clumped or paste-like ingredients into smaller pieces.

8. The stir-fry device of claim 1, wherein the connection part further comprises:
a spring disposed around the rotating shaft below the blade seat; a spacer and a retaining ring mounted on the rotating shaft below the spring, wherein the retaining ring is engaged with a slit of the rotating shaft to compress the spring and retain the rotating shaft within the blade seat while limiting displacement of the rotating shaft relative to a central axis of the cooking pot.

9. The stir-fry device of claim 1, wherein the blade seat includes a recess formed in a bottom surface of the blade seat, the recess receiving at least one magnet and an associated magnet cap, the magnet caps being interference-fitted into the recesses to permanently secure the at least one magnet to the blade seat.

10. The stir-fry device of claim 1, wherein the base connector has an upper portion of larger outer diameter than a lower portion, the lower portion extending through an opening in the bottom wall of the cooking pot and being fixed to the cooking pot by a threaded nut, and wherein the base connector defines a central opening through which the rotating shaft passes to couple to a driving part.

11. The stir-fry device of claim 1, wherein the connection part further comprises a blade seat having an overall gourd-shaped outer contour with a central indentation sized to provide a manual grip for counteracting magnetic attraction during removal of the connection part from a base connector, and wherein an internal stack of components is received within the connection part in a sequence including the blade seat, a top seal, a bushing sleeve, a bushing, a spring, a spacer, a retaining ring, and a bottom seal.

12. The stir-fry device of claim 1, wherein the magnetic material of the base connector comprises stainless steel AISI 430.
